(19) United States
(12) Patent Application Publication
(10) Pub. No.: US 2008/0096659 A1
(43) Pub. Date: Apr. 24, 2008

(54) Wireless communal gaming system

(76) Inventors: Shawn D. Kreloff, New York, NY (US); Peter J. Shoebridge, Boulder, CO (US); Andrew V. Brandt, Boulder, CO (US); Zbigniew Czyzewski, Henderson, NV (US); Mark L. Yoseloff, Henderson, NV (US)

Correspondence Address: Dickstein Shapiro LLP, 1825 Eye Street NW, Washington, DC, 20006, US

(21) Appl. No.: 11/585,026

(22) Filed: Oct. 23, 2006

(51) Int. Cl. A63F 13/12

(52) U.S. Cl. 463/39

(57) ABSTRACT

A system and method for wireless communal gaming in a casino environment. The system includes one or more wireless gaming devices each equipped with a display, one or more gaming servers configured to communicate wirelessly with the wireless gaming devices, and one or more financial servers configured to record financial transactions for players playing communal games of chance on the handheld gaming devices. The wireless approach to communal gaming allows greater player mobility within the casino establishment and also allows a large number of players (players playing wirelessly as well as players playing traditionally at a physical player station) to participate in a common game, thereby increasing the capacity of existing communal game tables. When the wireless game-playing option is available, a player can participate in the communal game regardless of whether there is a physical player station available. Thus, flexible game-playing options can be provided to casino patrons participating in a communal game.

### RELATED APPLICATION

This application is related to co-pending application Ser. No. ______, filed on the same date as the present application, and assigned attorney Docket No. PA1464.ap.US. The content of this application is incorporated by reference in its entirety.

### BACKGROUND

1. Field of the Disclosure

The present disclosure generally relates to casino gaming machines and, more particularly, to a wireless communal gaming system in which a communal game can be played by both mobile (wireless) and non-mobile gaming devices.

2. Brief Description of Related Art

Generally, there are two types of casino table games: (i) games with common outcomes (referred to herein as “communal games”) such as, for example, Baccarat, Roulette, Craps, and certain slot games; and (ii) games with player-specific outcomes such as, for example, poker. Certain communal games do not require the player to make any decisions other than placing a wager. Players may, however, wager on different outcomes in certain communal games. For example, in Baccarat, the player may choose to wager on the player hand, the dealer hand, or a tie. Thus, while the player may wager on different outcomes such that one player may win while another loses, the outcome of the game itself is common to all players. Other games, whether or not communal, require player decisions other than whether to place a wager and on what outcome to wager. For example, Blackjack requires the player to make decisions (hit or stay, double down or fold, etc.) and the game outcomes largely depend on the decisions players make during the game.

In a traditional casino environment, players play such games against a real or virtual dealer while sitting at a physical game table where the desired game is being played and those game tables have limited space for players. A substantial disadvantage to the way such games are currently presented is that a player may participate in a game in only certain specified locations within the gaming environment (e.g., a casino). For example, in order to play Baccarat, the player may have to travel through a large hotel/casino complex to a specific gaming area where the Baccarat table is located. Such a restrictive gaming environment hampers players' accessibility to different communal games and reduces their opportunities to play such games.

It is therefore desirable to devise a communal gaming platform that increases player capacity beyond that of existing communal game tables. It is also desirable to provide players with mobile or wireless gaming device access to traditional table-based communal games so that an increased number of players can play the same communal game regardless of whether a player is using a table-based, non-mobile gaming unit or a wireless/mobile gaming unit.

### SUMMARY

An embodiment of the wireless communal gaming system includes an interactive communal computer-based wagering game platform, the platform comprising a game server communicating game information by way of a hardwired connection with multiple physical player stations for playing the communal game and receiving a wager command from and providing a communal game outcome to a wireless gaming device by way of a secure wireless network.

In one embodiment, the present disclosure contemplates a gaming system that includes an interactive, communal computer-based wagering game platform having a game server and may include a device server in communication with the game server. The game server executes a communal game and may be the external game server discussed below or can be a unitary game server. The game server may be located either within or outside of the physical gaming machine and is capable of controlling the physical game and also providing game information to the wireless device controller or directly to the wireless devices. The game platform also includes a plurality of player stations communicating with the game server by way of a physical connection to enable a player at each player station to play the communal game executed by the game server. The device server is in further communication with a plurality of wireless gaming devices. The wireless gaming devices communicate with the device server over a secure wireless network to enable a mobile player operating each corresponding wireless gaming device to play the communal game executed by the game server. The device controller may operate in conjunction with one or more other servers such as the local game server discussed below.

In another embodiment, the present disclosure contemplates a method of playing an interactive communal game, wherein the communal game is one in which all players wager on a common outcome and in which player decisions are limited to selecting and placing a wager in a predetermined time period that is fixed for all players playing the communal game. The method comprises executing the communal game on a game server; enabling a player at each of a plurality of stationary player stations to play the communal game executed by the game server; and allowing a plurality of wireless gaming devices to wirelessly communicate with the game server so as to enable a mobile player operating each corresponding wireless gaming device to play the communal game executed by the game server.

The present disclosure also contemplates a method of operating a first wireless gaming device that includes selecting one of a first game having game rules executed by a local game server and a second game executed by an external game server and a gaming system. The gaming system includes a local game server executing rules for a first game, an external game server executing rules for a second game and communicating with the local game server, and a wireless gaming device communicating wirelessly with the local game server. The wireless gaming device of the gaming system has an input with which a user of the wireless gaming device may select to play the first game executed by the local game server or the second game executed by the external game server and a display on which is displayed a result of the selected game.

Currently, communal games are generally presented on large free-standing gaming devices (e.g., slot machines) or as table games (e.g., Blackjack, Baccarat, or Roulette) in a casino. The present disclosure relates to a system and method for playing communal wagering games in a casino environment in a wireless manner, allowing greater player mobility within the casino establishment and also allowing a large number of players to participate in a common game, thereby increasing the capacity of existing communal game tables. The wireless gaming approach according to one embodiment of the present disclosure may reduce or eliminate the need for the player to travel through a large hotel/casino to a specific gaming area where the desired gaming table is located.

Furthermore, the wireless gaming approach may further minimize search time for a player to search for a particular game and, potentially eliminate the wait time when a player finds that the desired game table location is occupied by another player. The wireless or mobile player may participate in the communal game regardless of whether there is a physical player station available. The system of the present disclosure includes one or more handheld gaming devices each equipped with a display, one or more gaming servers configured to communicate wirelessly with the handheld gaming devices, and one or more financial servers configured to record financial transactions for players playing communal games of chance on the handheld gaming devices.

### BRIEF DESCRIPTION OF THE DRAWINGS

For the present disclosure to be easily understood and readily practiced, the present disclosure will now be described for purposes of illustration and not limitation, in connection with the following figures, wherein:

FIG. 1 shows an interactive, computer-based communal gaming platform according to one embodiment of the present disclosure;

FIG. 2 illustrates structural details of an exemplary wireless gaming device that can be used in the gaming platform of FIG. 1;

FIG. 3 depicts an exemplary layout for a network-based implementation of the communal gaming platform of FIG. 1;

FIG. 4 provides additional networking details showing how mobile or wireless gaming devices can be used in the communal gaming platform of FIG. 1;

FIGS. 5A-5D are flowcharts that illustrate exemplary methods for initializing, funding and playing a communal game wirelessly according to embodiments of the present disclosure; and

FIG. 6 illustrates a node that may be used in any of the processor-based devices according to any embodiment of the present disclosure.

### DETAILED DESCRIPTION

Reference will now be made in detail to certain embodiments of the present disclosure, examples of which are illustrated in the accompanying figures. It is to be understood that the figures and descriptions of the present disclosure included herein illustrate and describe elements that are of particular relevance to the present disclosure, while eliminating, for the sake of clarity, other elements found in typical casino gaming systems.

It should be appreciated that aspects of the communal gaming systems, apparatuses, and methods described herein may also be included in processor-based apparatuses, multiprocessor-based systems, and articles of manufacture that contain instructions which, when executed by a processor, cause the processor to execute a communal gaming routine.

Any reference in the specification to “one embodiment,” “a certain embodiment,” or any other reference to an embodiment is intended to indicate that a particular feature, structure or characteristic described in connection with the embodiment is included in at least one embodiment and may be utilized in other embodiments as well. Moreover, the appearances of such terms in various places in the specification are not necessarily all referring to the same embodiment. References to “or” are furthermore intended as inclusive so “or” may indicate one or another of the ored terms or more than one ored term.

Embodiments of the present wireless communal gaming system are directed to a system that executes a communal game that may be played by multiple players, where all players wager on a common outcome that cannot be altered or delayed by player decisions. Players choose only whether to place a wager and, in some cases, on what outcome to wager. Regarding the common outcome, players wager on the same hands of cards, rolls of dice, etc., and do not individually receive different cards or dice throws. In a communal game, all players win or lose based on the same common game outcome. There may be more than one winning outcome in the games played on the wireless communal gaming system, but all game outcomes are common to all players participating in the game.

Theoretically, the games with common outcomes can be played by an infinite number of players at any given time because the players are not dealt their own cards, etc. and also because the players cannot influence the outcome or the pace of the game in any way. Furthermore, increasing the number of players directly increases the revenue generated by a casino per game. The number of players playing the communal games may, however, be limited due to the size limit of the system. For example, currently, a standard casino Craps table can accommodate up to 20 players, and a mini Baccarat table can seat up to 9 players. Therefore, embodiments of the wireless communal gaming system can allow many more players to participate in a communal game than is possible in the current gaming environment.

Also, a single deck game (e.g., a game with player-specific outcome) such as Three Card Poker® could be played in a communal game platform, but each player would have to wait for the decisions of other players, who are not required to play in turn and game progress would be slowed. Furthermore, the number of additional players in such single deck games is dictated by the number of cards left in the deck. Thus, in a 52 card deck, only 16 players and a dealer can play the Three Card Poker® game. Thus, games with player-specific outcomes may be less suitable for play using the wireless communal gaming system because there remains a limit on the number of players that can participate in the game.

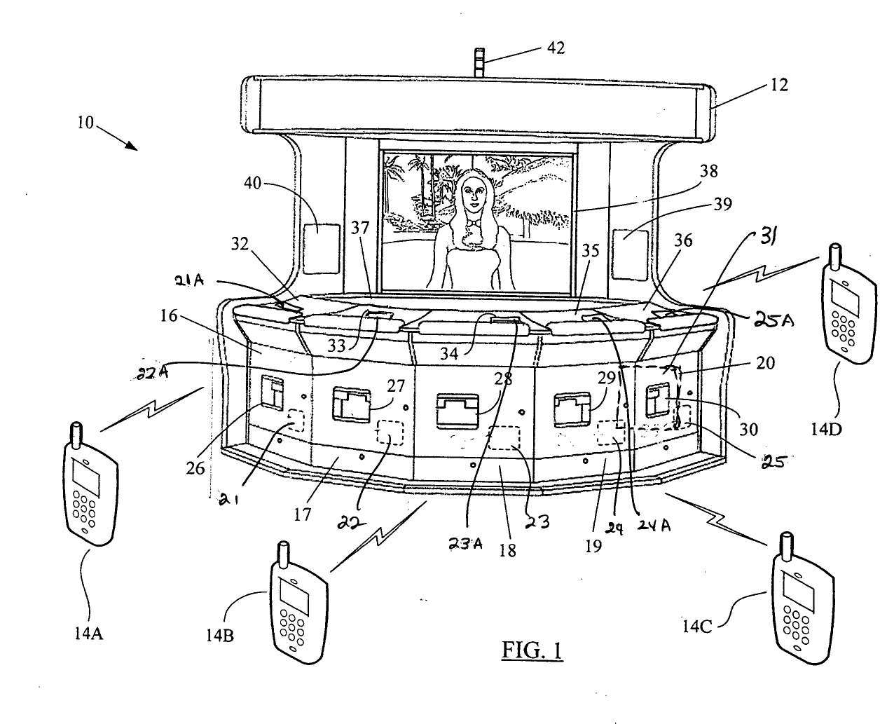

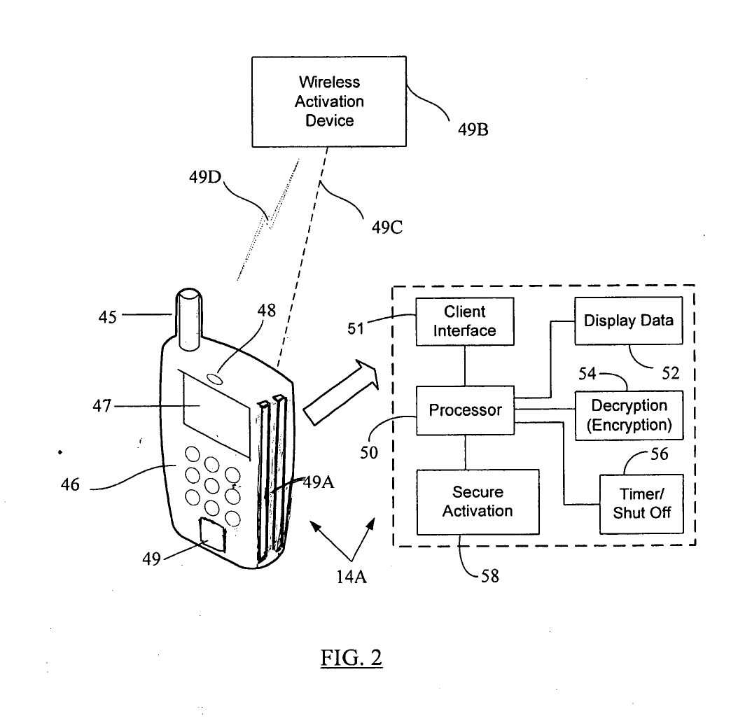

FIG. 1 shows an interactive, computer-based, wireless communal gaming platform 10 according to one embodiment of the present disclosure. The gaming platform 10 may be part of a casino and may include a non-mobile (or stationary) communal gaming system 12 in wireless communication with a plurality of mobile/wireless gaming devices (WGD) 14A-14D. Additional details about the wireless gaming devices 14A-14D are provided below, particulary with reference to FIG. 2.

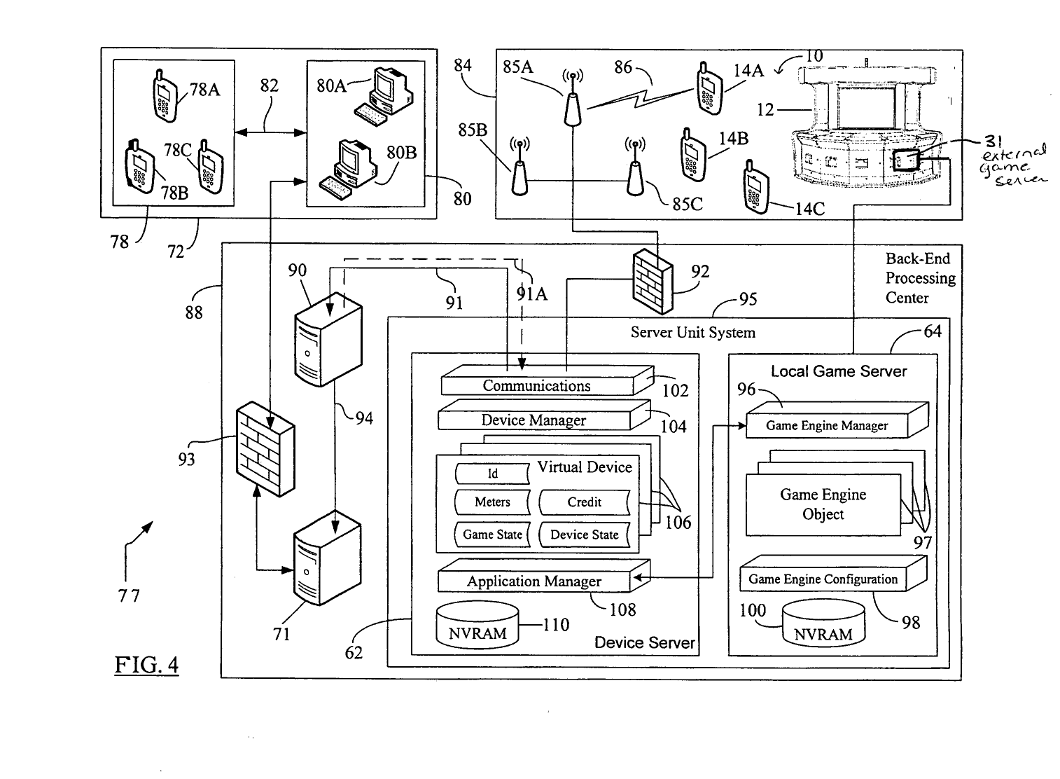

The gaming platform 10 includes an external game server 31, also referred to as an external game server, which may be internal to the platform 10 and/or system 12, but external to a back-end processing center (see FIG. 4) or control center in a casino, for example. Individual stationary player controllers 21-25 control operation of each player station 16-20. In one embodiment, one or more player stations (e.g., station 16-20) are controlled directly by the external game server 31. The individual player controllers 21-25 are coupled to the external game server 31 through cable such as, for example, an RS-232 cable, twisted pair, coaxial cable, or other metallic or fiber optics cable, for example. Such cable connected controllers 21-25 and player stations 16-20 operated by such cable connected controllers 21-25 are referred to herein as “hardwired” controllers 21-25 and player stations 16-20. The connection between the individual player controllers 21-25 and the external game server 31 may be a direct connection from each individual player controller 21-25 to the external game server 31 or may be through a networked, daisy-chained or other desired communication system.

The game server can comprise an external game controller, a game server, or can be a unitary game server, located either within or outside of the physical gaming machine. What is important is that the game server is capable of controlling the physical game and also providing game information to the wireless device controller.

The external game server 31 may provide functions including random number generation and virtual element production (e.g., cards or dice), determination of game outcome, application of game rules, maintenance of and application of minimum and maximum permitted wagers, and maintenance of and application of pay tables, in an embodiment. The external game server 31, alone or in combination with other processors, may perform gaming functionality including executing game logic, displaying a virtual dealer and any other desired video images on a virtual dealer display 38, displaying virtual game play elements such as cards, dice, or other indicia that indicate the status of the game to the players at player interface units 32-36 at one or more hardwired player stations 16-20, providing audio, which may be associated with the virtual dealer display 38, security, and reporting game results or other data desired to be acquired from the automated casino table gaming system. The external game server 31 may also determine and control the sequence of events occurring in the game, including when betting is opened or closed.

The gaming system 12 may include a number of hardwired player stations (e.g., the five hardwired stations 16-20 in the embodiment of FIG. 1) operated by the hardwired individual player controllers 21-25 that allow users to interact with a realistic, interactive virtual dealer displayed on a display screen 38 in a communal gaming environment. In the embodiment of FIG. 1, each hardwired player station 16-20 includes a corresponding payment (bills, coins, tickets, etc.) acceptor 26-30 to allow the user to pay for the game being played. The payment acceptors 26-30 may also be configured to accept payments in the form of cash (currency bills and/or coins), pre-paid vouchers available from the casino, ticket from a prior winning, a credit/debit card, or any other suitable payment means. Each hardwired player station 16-20 also includes a player interface unit 32-36 that may allow a player to place a wager, review betting history, view the communal game outcome, communicate to a casino attendant (e.g., for a service request or to report a problem with the hardwired player stations 16-20, etc.), view the winning bet/amount, or perform other desired functions. Each player interface unit 32-36 may include an individual display (e.g., a video display monitor or a touch-screen display) (not shown) to allow the player to view game-related information, an input device (e.g., a set of push-buttons or touch-screen keys) (not shown), and one or more audio speakers (not shown) to play casino music or game-related messages, announcements, or instructions. The construction, operation, and functionality of typical hardwired player stations 16-20 are known to one skilled in the art and, hence, additional discussion for the hardwired player stations 16-20 is not provided herein for the sake of brevity.

In the embodiment of FIG. 1, the gaming system 12 also includes a deal display area 37 and the life-like, realistic dealer display 38 operated by the external game server 31. The deal display area or “table” 37 may display the dealer's hand as well as wagers/bets placed by other players on the “table” (i.e., the players playing through the hardwired player stations 16-20). Thus, the deal display area 37 may effectively simulate a live gaming table experience along with a realistic dealer video displayed on the display 38. The dealer video may provide a life-like display or simulation of a human dealer conducting the game at the gaming system 12. The dealer video may attract casino patrons to the gaming “table” and encourage them to play the game at the table. In one embodiment, more than one dealer videos may be available to switch from one displayed dealer to the other. For example, a video of a male dealer with a casino in the background may be changed to a female dealer with palm trees and a sandy beach in the background. The gaming system 12 may also include additional (or ancillary) display screens 39-40 to display additional game-related information (game rules, game pay table, etc.) or information (e.g., current status, score card, etc.) about other casino games that may be of interest to the patrons at the physical player stations 16-20. In one embodiment, all of the display screens—i.e., the displays of the hardwired player stations 16-20, the deal display area 37, the dealer video display 38, and the ancillary video screens 39, 40—in the gaming system 12 are projection, plasma, LCD or other large size displays.

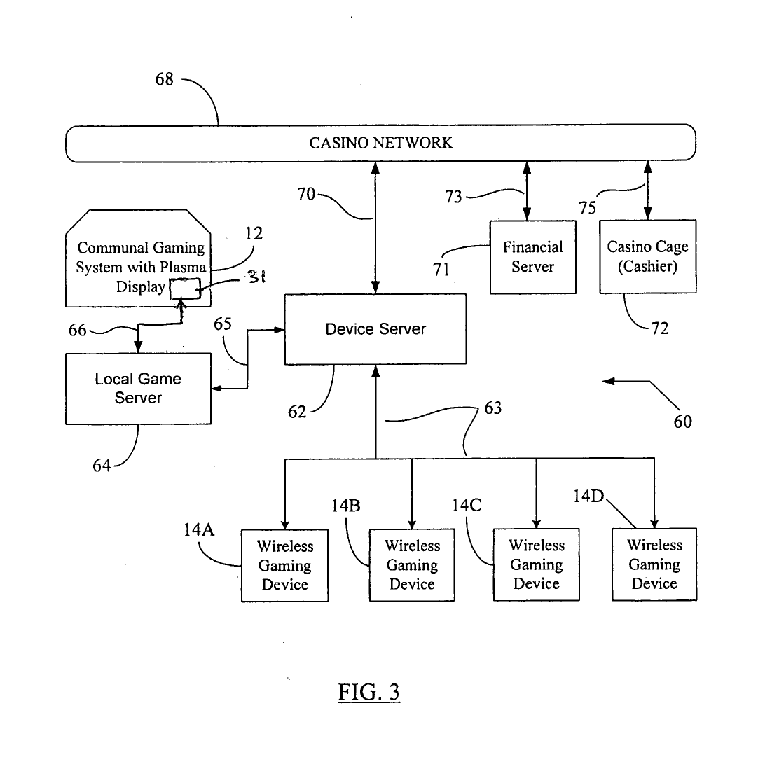

The gaming system 12 may also include an indicator 42 at the top thereof to allow a player to draw attention of a casino employee (e.g., a maintenance person or a bar service attendant) to the hardwired player stations 16-20 for assistance with player's needs. The indicator 42 may illuminate when activated. In the event of any malfunction or irregularity sensed by a processor (not shown) or the controller 31 in the gaming system 12, the indicator 42 may automatically illuminate to draw a casino employee's attention to the problem. In the wireless gaming platform 10 of FIG. 1, the indicator 42 on the “main” gaming system 12 may also function as an antenna for communication with various handheld wireless devices (e.g., wireless gaming devices 14A-14D) also participating in the same communal game being played at the “table” 37 in the system 12. Further details of the wireless gaming environment according to one embodiment of the present disclosure are provided below with reference to FIGS. 3-4.

It is noted here that, in one embodiment, an automated casino table gaming system such as the Table Master™ system, the Vegas Star® system, or the Rapid Roulette® system, all marketed by Shuffle Master, Inc., of Las Vegas, Nev., USA, may be used as the gaming system 12 with suitable modifications (as discussed, for example, with reference to FIG. 3 below) for wireless device support and wireless game playing options. United States Patent Publication Numbers US 2005-0164759 A1 and US 2005-0164762 A1 discuss such systems and are incorporated herein by reference. The automated casino table gaming system 12 includes a virtual dealer display and at least one player display driven by the external game server 31 and a plurality of stationary hardwired player stations 16-20, with one individual player controllers 21-25 located at each individual player position.

The Table Master™ system and Vegas Star® system provide popular table games like Royal Match 21™, Blackjack, and Three Card Poker® in an automated environment (without a live dealer present). A casino operator may easily switch between games offered through the Table Master® or Vegas Star® systems by installing a compact disc (CD) or other media carrying the game code for the new game and suitably changing game-playing button panels, table top design, and marquee overlays related to the new game. Such flexibility in game support is further increased by availability of a large number of “interactive” dealers and background screen options for the video display 38. In one embodiment, the dealers and background screens may be customized according to a casino's preference instead of requiring the casino to utilize “standard” dealer videos. Thus, a suitably modified Table Master™ or Vegas Star® system may be used to provide wireless communal gaming in addition to local gaming and, thereby, attract and accommodate more players in a communal gaming environment.

The Rapid Roulette® system includes a physical roulette wheel and may include players wagering directly at the physical roulette wheel. The Rapid Roulette® system may also include a camera capturing and transmitting an image of the physical roulette wheel to one or more other locations, whether near the physical roulette wheel or distant from the physical roulette wheel. Additional players may then wager on spins of the wheel at the other locations. A Rapid Roulette® system may thus also be modified to provide wireless communal gaming in addition to local gaming and, thereby, to attract and accommodate more players in a communal gaming environment.

FIG. 2 illustrates structural details of an exemplary wireless gaming device (WGD) 14A that can be used in the gaming platform 10 of FIG. 1. The WGD 14A in FIG. 2 is identical to the other devices 14B-14D in the platform 10 and is shown in FIG. 2 as representative of wireless gaming devices that may be used in the platform 10, regardless of whether shown in FIG. 1. Hence, the discussion provided herein for the WGD 14A in FIG. 2 equally applies to all other wireless gaming devices that may be used in the communal gaming platform 10 of FIG. 1.

In one embodiment, the wireless gaming device 14A includes an antenna 45 for wireless communication with a local game server 64 (shown in FIG. 4 and discussed below), a plurality of player controls 46, a player-viewable display 47, an optional audio speaker 48 and also an optional security device such as, for example, a card reader 49A or a fingerprint reader 49. Although the antenna 45 is shown visible in the embodiment of FIG. 2, it may be internally mounted in other embodiments. The card reader 49A may be of any type desired including, for example, a magnetic strip reader or a bar code reader. The fingerprint reader 49 or card reader 49A may be used for secure activation of the wireless device 14A. Any desired secure activation device or method or combination of secure activation steps may be employed. In one embodiment, the fingerprint reader 49 or card reader 49A in combination with a player identifier entered into the wireless gaming device 14A are required to be used periodically to assure that the proper player is using the wireless gaming device 14A. In another embodiment, a wireless activation device 49B that activates the wireless gaming device 14A when it is proximate via wireless communications 49D, or wired 49C, to the wireless gaming device 14A and that can be worn by a user, for example on their wrist (e.g., a wristband including a wireless transmitter), may be provided along with or in place of the fingerprint reader 49 or card reader 49A.

The dotted box on the right-hand side in FIG. 2 illustrates internal processing for an embodiment of the WGD 14A. As shown therein, a processor 50 resides in the WGD 14A and executes a number of software applications including, for example, a client interface application 51, a data display software application 52, a decryption (and, optionally, an encryption) software application 54, and a secure activation software application 58. The software applications may be resident in the processor's local memory (not shown). The processor 50 may also operate a timer/shut off switch 56 that may be implemented in hardware or software.

The client interface application 51 may be a browser or “thin client” (i.e., client application that depends primarily on the device server 62 for processing activities) operating system, for example, and may translate data received at the wireless gaming device 14A and operate in conjunction with the data display software application 52 to display that data as appropriate for viewing by a wireless gaming device 14A user.

As noted before, the processor 50 in the WGD 14A may execute any or all of the following software applications: (1) a client interface software application 51, which is to receive and translate data received from the wireless device server 62 or local game server 64; (2) a display software application 52, which is provided to control the appearance of the data received from the device server 62; and (3) a decryption software application 54, which is used to retrieve secure data sent from the device server 62 via the wireless communication link 63.

It is observed here that various portable/mobile electronic computing devices may be used, upon suitable modifications known to one skilled in the art, as the wireless gaming device 14A. Such portable devices may include, for example, a PDA (Personal Digital Assistant), a mobile computer, a custom-made tablet PC (personal computer) (custom made for casino gaming applications), a suitably-configured cellular phone, etc.

The following description of FIG. 2 is provided in conjunction with the network architecture illustrated in FIG. 3, which depicts an exemplary layout 60 for a network-based implementation of the communal gaming platform 10 of FIG. 1 with wireless gaming devices 14A-14D. During operation, a menu of game options supported by the gaming system 12 or the local game server 64 may be displayed on the wireless gaming device display 47, which may be a regular or touch-sensitive LCD (Liquid Crystal Display) screen with low power consumption. In an embodiment of the wireless communal gaming system 12, game rules are executed on a processor that is part of the external game server 31 within the wireless communal gaming system 12 and state machine management for the wireless gaming devices 14A-14D is performed on a processor that is part of the local game server 64. Thus, wireless gaming device 14A-14D users may select one of a plurality of wireless gaming systems 12 to play through the local game server 64. The player can then select the game, and a server (not shown in FIG. 2, but shown as local game server 64 in FIG. 3). Operating the gaming system 12 will send (through, for example, the device server 62, also referred to herein as a wireless device server 62, shown in FIG. 3) appropriate game data to the WGD 14A for display based on that selection. The random number generator and game rules reside on the local game server 64 in an embodiment. The wireless gaming device 14A processor 50 does not control game functions, nor does it execute any game code. All game functions, including the random selection of game outcomes, reside on the external game server 31 (FIG. 1) the local game server 64 or both, if desired. In one embodiment, the only functions of the wireless gaming device 14A during play are to send player's game selection information, game play information, and wager information to the device server 62 and to display game information provided by the server 62. The player enters the game selection or wager information using the player control buttons 46 on the WGD 14A or, if available, using touch inputs to the touch-screen display 47 as is known to one skilled in the art.

FIG. 3 (and FIG. 4 as is described below) illustrates the servers 62 and 64 as being different servers. It should be appreciated, however, that the functions of the device and local game servers 62, 64 may be implemented in one server, if desirable and practical. Moreover, the functions of the other servers illustrated in FIGS. 3 and 4 (e.g., financial server 71, logging server 90, etc.) also may be implemented in one or more servers, if desirable and practical.

Once a game is selected and during game play, the local game server 64 may perform such functions as parameter validation to assure the WGD 14A-14D users are following house rules. For example, the local game server 64 may determine whether the wireless gaming device 14A-14D user is attempting to wager more than the maximum wager permitted or attempting to wager less than the minimum wager permitted, and whether the wireless gaming device 14A-14D user is attempting to place a wager at an inappropriate time. The local game server 64 may then prevent the wireless gaming device 14A-14D user from performing any such activity falling outside the house rules and, if desired, inform the wireless gaming device 14A-14D user they are attempting an improper operation and ask that the user place a wager conforming to the house rules.

It is noted that both the external game server 31 and the local game server 64 may have the capability to select random numbers, convert those random numbers into game elements such as cards or dice used in game play, and execute game rules. Thus, a wireless gaming device 14A user may select to play a game directly on the local game server 64 or may select to play a game being played at a stationary gaming system 12 with live players sitting or standing at the gaming system 12 through the local game server 64.

In one embodiment, the WGD 14A may be a “thin client” without any audio features. However, in the embodiment of FIG. 2, the WGD 14A is shown with optional audio speakers 48 to enable the player to hear game-related announcements or game background music, etc. As noted before, none of the game logic or game outcomes are stored in the WGD 14A. Such thin client architecture avoids storage of game rules, random number generation, and the like, and also avoids the need to perform security checks of the code executed by the wireless gaming device 14A. In one embodiment, only the data being received by the wireless gaming device 14A is secured (as indicated, for example, by the availability of decryption software application 54 in the wireless gaming device 14A). Any regulatory validation required by applicable gaming laws is stored as part of the game logic or game code in the local game server 64 (or, alternatively, in the wireless device server 62).

Alternatively, in one embodiment, the local game server 64 may be physically part of (i.e., incorporated within the housing of) one of the hardwired player stations 16-20 of FIG. 1, but protectively secured within the body of the hardwired player stations 16-20. Because the regulatory validation information is stored in the local game server 64, if someone hacks graphics at the wireless gaming device 14A to make it look like a winning outcome, such tampering can be easily verified with the secure game code stored at the local game server 64 with pertinent regulatory validation. Furthermore, an encrypted or security “key” may be used in communication between the wireless gaming device 14A and the device server 62 to avoid hacking into the local game server 64 through the device server 62 from the WGD 14A. During game play, such security keys may be temporarily stored in the device server 62 and the wireless gaming device 14A in communication with the device server 62.

Thus, in one embodiment, the wireless gaming device 14A acts as a dummy display terminal in that it functions merely as a player/game interface. The game code, including the game logic and regulatory validation information, resides on the external game server 31 such that game code is not executed on the wireless gaming device 14A. The wireless gaming device 14A displays a graphical representation of a game based on messages coming from the device server 62. The graphical game representation on the wireless gaming device 14A is capable of taking user input in the form of menus or other predefined choice controls. User input to the wireless gaming device 14A may be limited to the game choices permitted for any given game state and the game state may be controlled by the external game server 31 through the device server 62 and/or the local game server 64. The display data software application 52 (in the wireless gaming device 14A) for displaying the graphical representation of the game can be either a general purpose thin-client application (e.g., a browser capable of providing support for multiple games) or it can be an optimized code for one or more specific communal games. In any event, the wireless device server 62 provides display content information to the wireless gaming device 14A, for example, to attract the player to place a wager or in response to input from the player.

Encryption software (shown as an optional component of the decryption application 54) can also reside in the processor 50 to secure data being sent to the device server 62. Encryption/decryption software may also reside on the device server 62 to secure data being sent to the WGD 14A. In one embodiment, the messages between the device server 62 and the wireless gaming device 14A are made secure using a strong encryption method. Optionally, the messages may be encoded to minimize the message size. The decryption software application 54 (which may be part of the graphical game representation code in the wireless gaming device 14A) decrypts the messages and/or optionally decodes the messages. Secure activation software application 58 may be provided to power up the WGD 14A after automatic shut-off (discussed below). The player could be required to enter a “pin” (i.e., personal identification number) number, insert a card, place a finger on an optional fingerprint reader 49, or come into close proximity to a wireless activation device 49B affixed to the wrist of the player, for example, to activate the wireless gaming device 14A. The wireless activation device 49B (e.g., a wrist-band based wireless transmitter) could send an activation signal that would be received by the wireless gaming device 14A upon being powered up using a short range wireless communication link 49D. Alternately, the player may connect the wireless gaming device 14A into a wristband activation device via a hardwire connection (49C) or use any other desired activation device or information entry device.

The processor 50 may also operate the timer and shut off switch 56 (if in hardware) or may include a software timer to de-energize the display 47 of the wireless gamine device 14A to preserve the batteries of the wireless gaming device 14A. The wireless gaming device 14A could become inactive (automatically shut-off the display or other functions) through the timer and shut off switch 56 if not used for a predetermined period of time. The timer 56 could also reside in the device server 62 and send a command to the processor 50 to shut off the wireless gaming device 14A after a predetermined time has elapsed without play. The wireless gaming device 14A could then be re-activated using the secure activation software 58 described above.

It is seen with reference to the wireless communal game network layout 60 in FIG. 3 that the local game server 64 executes and carries out the communal game at the physically hardwired player stations 16-20 in the FIG. 1 gaming system 12 and also supports wireless communal gaming through the device server 62, which is wirelessly linked to various wireless gaming devices 14A-14D via the wireless communication link 63. The communication over the wireless link 63 may employ any of the presently-available wireless communication protocols including, for example, IEEE 802.11a, IEEE 802.11b, IEEE 802.11x, HyperLan/2, Bluetooth, IrDA, and HomeRF. The wireless communication may utilize RF (Radio Frequency) or IR (InfraRed) signals for data transfers. In one embodiment, the wireless data transfer may employ the IEEE 802.11b compliant wireless interface utilizing 2.4 GHz Direct Sequence Spread Spectrum (DSSS) radio system with a communication range of up to 330 ft (inside a building) from any access point and data transfer rate of 11 Mbps. In one embodiment, the device server 62 and the local game server 64 both include respective serial communication ports (not shown). In that case, the communication link 65 is a serial communication link. The communication link 65 can also be a wireless link or a USB, IEEE 1394 or Ethernet link. Similarly, the communication link 66 between the local game server 64 and each individual hardwired player station 16-20 (FIG. 1) in the communal gaming system 12 (FIG. 1) may also be a serial communication link connecting a serial port (not shown) on each hardwired player station 16-20 with a serial port (not shown) on the local game server 64. As in case of the communication link 65, the communication between the hardwired player stations 16-20 in the gaming system 12 and the local game sever 64 may also be accomplished via a wireless, USB, IEEE 1393, or Ethernet communication link 66.

In one embodiment, the wireless device server 62 is in communication with the overall casino data network 68 via a wireless communication link 70, which can be operative under any of the aforementioned wireless communication protocols (e.g., IEEE 802.11b, Bluetooth, etc.). Link 70 can also be a wired link, if desired. The casino network 68 may link various such device servers 62 operating throughout the casino (to control and manage wireless gaming through respective groups of wireless gaming devices 14A-14D) with other data and account management systems in the casino operating network 68. Such data and customer account management systems include, for example, a financial server 71 and a casino cashier's “cage” 72 with player management stations (not shown in FIG. 3, but shown as management workstations 80A-B in FIG. 4). The financial server 71 may be configured to track the value of each wireless gaming transaction and securely maintain each wireless game player's account information to facilitate wireless gaming within the casino network 68. In a large casino environment, there may be more than one financial server associated with the casino network 68. In one embodiment, the financial server 71 may communicate with other devices operating in the casino network 68 by a communication link 73, which can be a wireless link (e.g., IEEE 802.11b or Bluetooth, etc.) or a hardwired link such as a serial communication link connected to a serial port (not shown) on the financial server 71. The casino cage or cashier station 72 may include a player transaction station 80 (FIG. 4) including a number of computer terminals (e.g., workstations 80A-B shown in FIG. 4) operated by casino employees and handling such routine transactions as, for example, checking out wireless gaming devices 14A-14D to casino patrons, performing electronic fund transfers to a player's account, paying out winning bets, maintaining and settling a player's account, etc. The computer terminals (e.g., workstations 80A-80B of FIG. 4) in the casino cage 72 may be linked to the other devices in the casino network 68 by another communication link 75, which can also be a wireless link (e.g., IEEE 802.11b or Bluetooth, etc.) or a hardwired link such as a serial communication link connected to various serial ports (not shown) on the computer terminals in the cashier's cage 72.

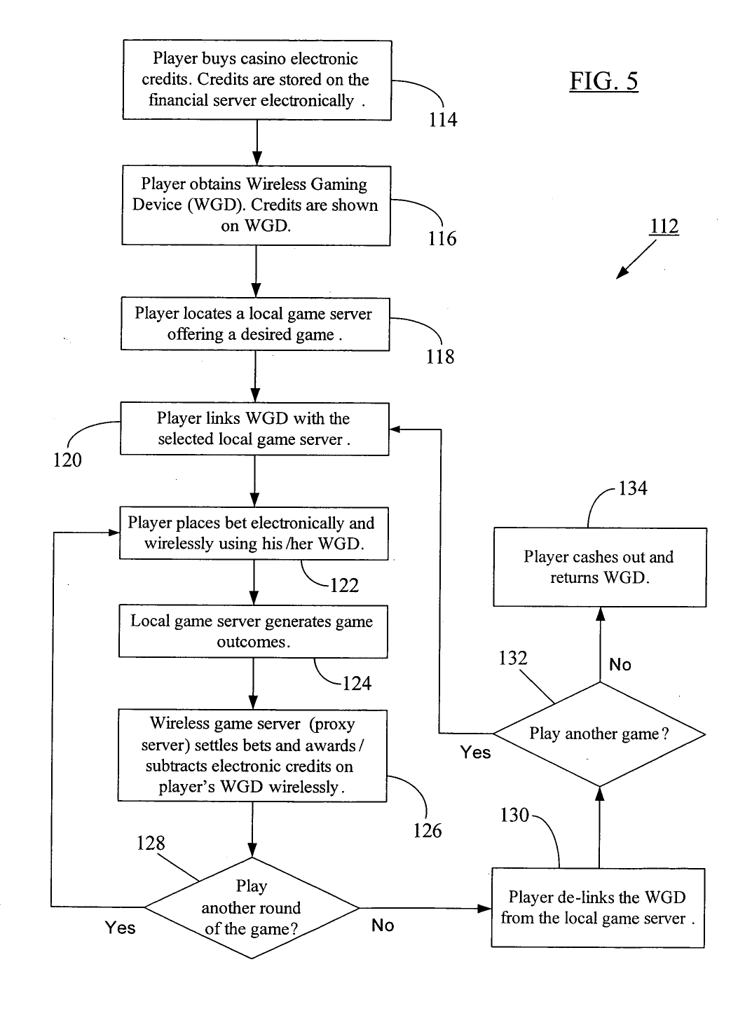

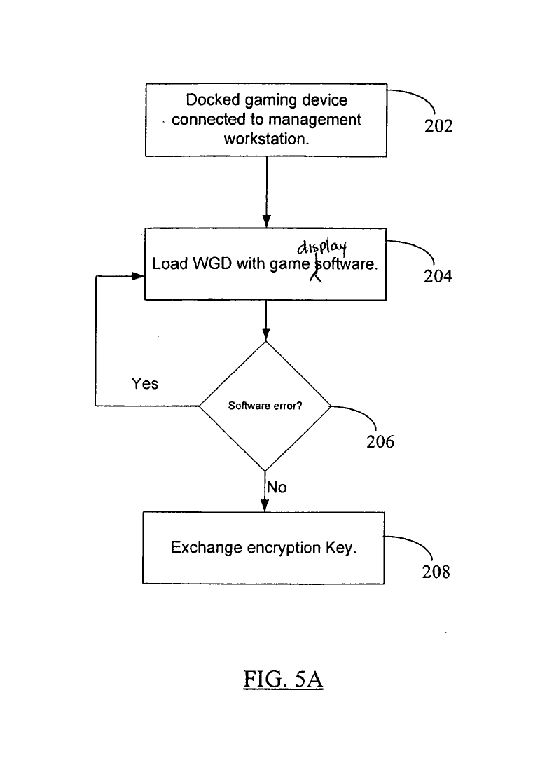

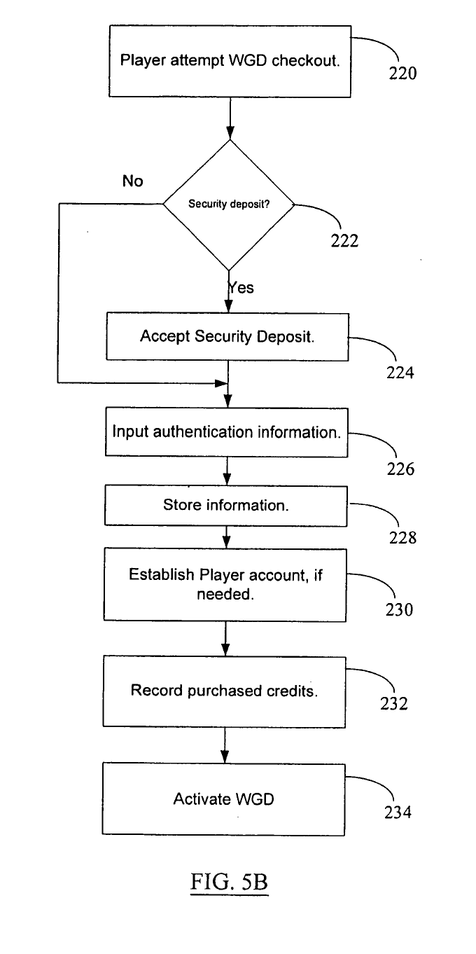

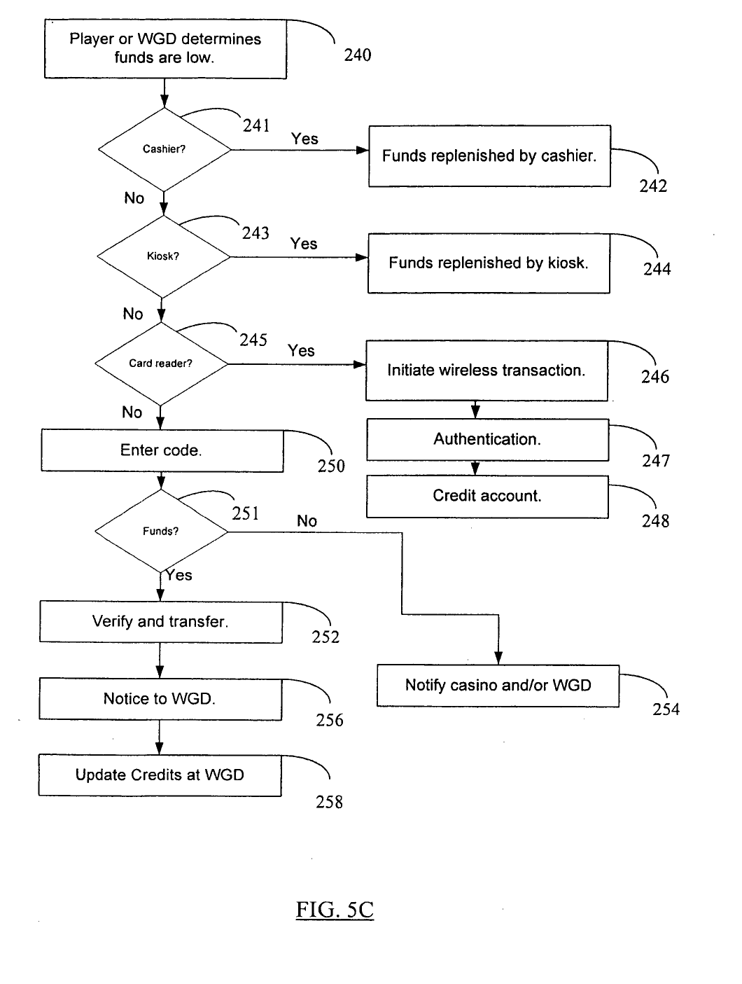

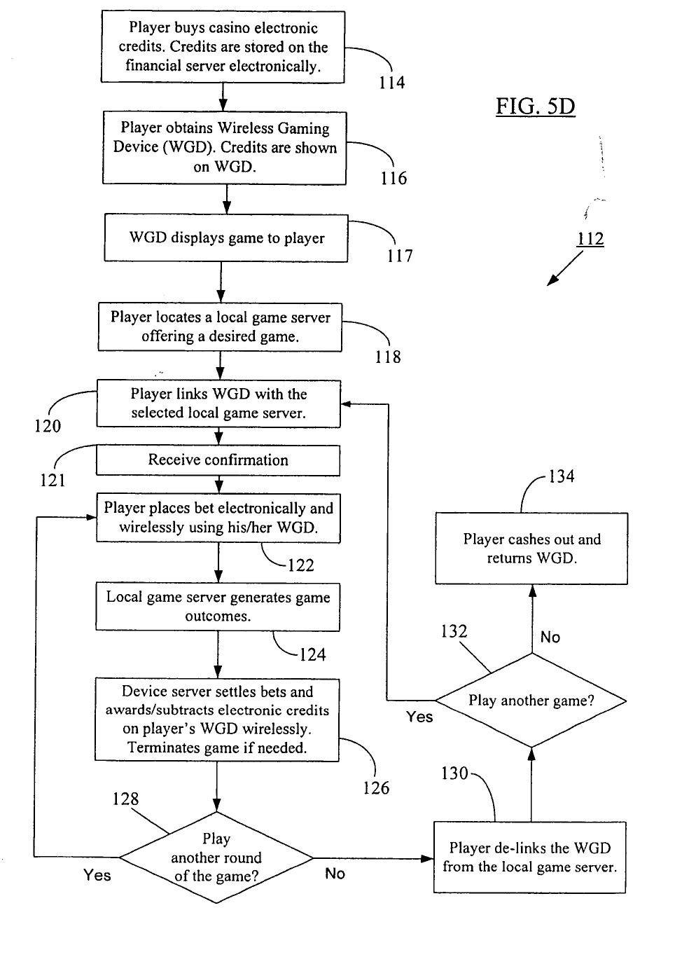

FIG. 4 provides additional networking details showing how mobile or wireless gaming devices 14A-14D can be used in the communal gaming platform 10 of FIG. 1, and FIG. 5D illustrates an exemplary operational method 112 for playing a communal game wirelessly according to one embodiment of the present disclosure. The back-end processing layout 77 in FIG. 4 provides additional details on the system-wide architectural considerations involved in implementing the wireless communal game network 60 in FIG. 3, whereas, the method 112 in FIG. 5D shows operational details of wireless communal gaming according to one embodiment of the present disclosure. The below discussion is provided with reference to FIGS. 4 and 5A-5D, wherein structural or system aspects are discussed primarily with reference to FIG. 4, and corresponding operational or transactional aspects are discussed primarily with reference to FIGS. 5A-5D.

As shown in FIG. 4, a back-end processing center 88 may include a secure server unit system 95 providing one or more servers for wireless communal gaming and which may also provide support for stationary, hardwired physical communal gaming. The wireless device server 62 provides secure communication with the mobile client devices or WGDs 14A-14C, tracks credit meters for each checked-out mobile client device, and applies pay tables to game results to update the credit meters. The local game server 64, on the other hand, executes the relevant game code and may provide, in combination with controller 31 or on its own, gaming support for stationary hardwired player stations 16-20 (shown in FIG. 1) in the gaming system 12.

As illustrated in FIG. 4, the wireless gaming devices 14A-14C communicate wirelessly with the wireless device server 62, which may, in turn, communicate with one or more other servers in the system layout 77, such as, for example, a logging server 90 that provides logging of transactions, system events and game outcomes, as well as the financial server 71 that provides account management, reporting, workstation authentication, and limited game server management. The financial server 71 may further communicate with management workstations (e.g., workstations 80A-B) at various locations where wireless gaming devices 78A-78C are docked when unused and checked-out to players. The management workstations 80A, 80B permit the docked wireless gaming devices 78A-78C to be loaded with software, verified, and associated with an account. The workstations 80A, 80B may also manage the account by, for example, transferring funds received from a player to the servers. The functionality described in connection with those servers 62, 71, 90, etc. may alternately be divided or aggregated among servers as desired. The communication between servers 62, 71, 90 and wireless gaming devices 78A-78C may be made secure through encryption/decryption.

Prior to commencing wireless gaming, a player may need to check out a WGD 78A-78C from a cashier's cage 72. In FIG. 4, an exemplary wireless gaming device docking station 78 is shown containing three WGDs 78A-78C. These wireless gaming devices 78A-78C are identical to the devices 14A-14D shown in FIGS. 1-3, but are provided with different reference numerals to distinguish docked wireless gaming devices from the checked-out or issued/operational units (e.g., devices 14A-14D in FIG. 1). Three such operational wireless gaming devices 14A-14C are shown operating on the casino floor 84 and in communication with various wireless access points 85A-85C located throughout the casino floor 84. In one embodiment, to preserve the confidentiality and security of gaming transactions, communication between wireless gaming devices 14A-14C and wireless access points 85A-85C is carried out over a secure wireless channel 86. It is noted here that the embodiment illustrated in FIG. 4 is for illustration purpose only. It should be evident to one skilled in the art that the structural layout 77 in FIG. 4 is representative in nature, and does not purport to convey all implementational details of a communal wireless gaming platform. For example, although three wireless gaming devices 78A-78C are shown docked in the docking station 78, there may be many more such devices present in an actual casino docking station 78. Similarly, there may be many more wireless gaming devices on the casino floor 84 than the four representative devices 14A-14D shown in FIG. 1. Additionally, the wireless gaming devices on the casino floor 84 may be operating with different wireless access points (e.g., when devices are in different physical locations in the casino, or when devices are linked to different communal gaming systems 12, etc.) than the three points 85A-85C shown in FIG. 4. Also, there may be more than two wireless device management workstations 80A, 80B in the cashier's “cage” 72. All such additional implementational details are not shown or discussed herein for the sake of brevity.

In one embodiment, as illustrated in the flowchart of FIG. 5A, the docked mobile devices 78A-78C in the docking station 78 may be electronically connected to and operatively controlled by the workstations 80A-80B via one or more USB (Universal Serial Bus) links 82 carrying out data transfers between a workstation 80A-80B and a corresponding wireless gaming device 78A-78C (block 202). Other suitable ways (e.g., serial ports, wireless links, etc.) to carry out such data transfers may be conveniently implemented as desired. In one embodiment, the management workstations 80A-80B load the wireless gaming device 78A-78C with appropriate software (block 204) to enable the WGD 78A-78C to display a communal game on its display so as to allow the player to carryout interactive wireless gaming (including wagering, receiving and displaying game results and payout information, etc.). As noted above, no random number generation (RNG) or game code execution takes place at the gaming device 78A-78C. Such transactions are carried out securely at the external game server 31, the local game server 64, or elsewhere in the wireless communal gaming platform 10. In one embodiment, the management work stations 80A-80B may also verify whether the software loaded onto the wireless gaming device 78A-78C being checked-out or cradled in the docking station 78 is error-free (block 206). If an error is detected, the management workstation 80A-80B reloads the appropriate software (i.e., repeats block 204). In one embodiment, the management workstation may exchange an encryption code or “key” with a docked mobile device 78A-78C prior to the device being checked-out so as to prevent any misuse or tampering by the player (block 208). Such encryption code, for example, may prevent the player from operating the WGD 78A-78C on a network other than the casino network 68 or from tampering with the game results displayed on the WGD 78A-78C, etc.

In operation, as shown in FIG. 5B, the player may be required to first check out a wireless gaming device (e.g., device 78A) at a teller terminal (i.e., cashier's cage 72) or from another secure location (e.g., an electronic device dispenser or cradle) in the casino or other establishment providing the wireless gaming experience (block 220). In case of an automated, electronic device dispenser, a security deposit (e.g., a hold for a specific amount on a player's credit card) may be required before allowing the player to check-out a WGD (block 222). If a security deposit is required, it is accepted at block 224. In one embodiment, at the time of check-out, an authentication procedure may be performed by the terminal or cage operator (not shown), whereby a player ID (for the player checking out the wireless gaming device) is inputted into the wireless device server 62 through, for example, a teller terminal or workstation (e.g., workstation 80A or 80B) and is associated with the device-ID number of the wireless gaming device 78A (block 226). This association may be stored in the wireless device server 62 through its device manager unit 104 so as to, for example, enable the system 95 to track the device and its player when needed (block 228). The game data (e.g., player's wagers, winning outcomes, etc.) generated during game play and stored (by player ID, for example) in the memory (e.g., the non-volatile random access memory or NVRAM 110 in FIG. 4) of the wireless device server 62 may later be associated with account information in the financial server 71 (which may also be organized by player ID) and the account can then be reconciled after play. All financial transactions may be reported to the financial server 71 to avoid any financial discrepancy or disputes. In this regard, the players may need to establish an account with the casino prior to checking out a wireless gaming device 78A-78C (block 230). Moreover, the plays may be on credit only.

Similar to traditional “buy-in” at a casino, a player may be required to purchase some electronic credits (e.g., a payment of $100 may buy 100 electronic credits) that can be stored in the WGD 78A-78C to be checked-out in order to activate the WGD 78A-78C (block 232). The player may authorize the cage operator to charge the player's credit card for a specific amount, which can then provide corresponding wagering credits to the player, for example. The player can also pay cash for future wagering. In any event, funds are typically associated with the wireless gaming device 78A-78C being checked-out and with the player account (in the financial server 71) at the time of device checkout so as to activate the wireless gaming device 78A-78C and enable the player to participate in the gaming (block 234).

It is observed here that the active wireless gaming device 14A-14D may not directly communicate with the financial server 71, if desired. Rather, in one embodiment, the financial server 71 may receive data for all financial transactions from the device server 62 and or from the workstations 80A-80B in the casino cage 72. Any other terminals handling financial transactions for wireless gaming devices (e.g., stand-along kiosks discussed below) may be connected to the device server 62 through the casino network 68. The device server 62 may then appropriately channel the transaction to the financial server 71. The financial server 71 may also receive such financial transaction information from the local game server 64 or from other player accounting machines through, for example, secure messaging over the casino network 68 or via the device server 62 (as, for example, in the embodiment of FIG. 4). Such player accounting machines may include credit machines where players apply currency and/or credit to an account from which play using the wireless gaming device 14A-14C will be transacted with wagers deducted from the player account and winnings credited to the player account. Alternately, as noted before, teller terminals (e.g., workstations 80A-80B) may be used to apply credit to a player account or withdraw credit from a player account and may report such transactions to the financial server 71. The financial server 71 and the wireless device server 62 may both reside on the casino computer network 68 and may both store and exchange relevant information.

The device server 62 may create a data object for each player playing on the wireless gaming devices 14A-14C as indicated by the virtual device objects 106 in FIG. 4. This object 106 may include data pertaining to the player's current financial credit (“Credit”) (updated based on the player wagering information received from the wireless gaming device 14A), a player identifier (“Id”) for authenticating the player, wireless gaming device 14A-14C activation and operational state (“Device State”), status information obtained from tracking a device meter (not shown) in the wireless gaming device 14A-14C (“Meters”), and data reflecting the current state of the game (“Game State”), among other things. The device meter in the wireless gaming device 14A-14C may record numerical identifiers of the games played on the wireless gaming device 14A-14C along with a numerical count of each wagering attempt by the player. The Game State information may include such information as whether the player has wagered in the most recent round of the game, has terminated the game play, has been inactive in the game play, whether the game has been concluded, etc. The device server 62 may also include an application manager unit 108 to communicate with the local game server 64 to obtain the information about the communal game that is currently being executed by the game server 64 and offered to wireless and non-wireless players. Through the application manager 108, the device server 62 can offer the communal game to mobile players on wireless gaming devices 14A-14C. As noted before, the device manager 104 in the device server 62 may provide an initial interface between the wireless gaming devices 14A-14C and the device server 62 and supports communication between them. The communications unit 102 in the device server 62 implements appropriate communication protocol to facilitate secure wireless data communication between the wireless gaming devices 14A-14C and the device server 62. In one embodiment, the wireless communication may be based on the Wi-Fi standard A0211, which uses public radio bands. Further, the communication between the wireless device server 62 and the wireless gaming devices 14A-14C may be accomplished through standard TCP/IP (Transmission Control Protocol/Internet Protocol) or UDP (User Datagram Protocol)/IP based server and browser applications, permitting information to be communicated to be arranged into frames at the data link layer, permitting routing of data to be determined at the network layer, and permitting division of messages into packets through TCP/IP or UDP/IP at the network and transport layers, as is standard when using browsers. The UDP/IP protocol is a packet switching network communications protocol that is similar to TCP/IP, but offers lesser services than TCP/IP. For example, UDP/IP may not provide sequencing of the packets or retransmission of unreceived packets as is typically the case with TCP/IP. In UDP, after the packets are created, the IP layer (comprising the network and transport layers discussed above) transmits the packets across a network such as the Internet. UDP finds its use primarily in applications requiring streaming media where data are transmitted and received in or nearly in real-time.

As mentioned above, various game-related data (e.g., wagering inputs, game outcomes, time-out events, missed or wrong wagers, etc.) may be stored in the memory 110 of the device server 62 for ease of later retrieval, whenever needed. The NVRAM 110 primarily stores game-related data for gaming transactions conducted by players operating wireless gaming devices 14A-14C on the casino floor 84. On the other hand, a similar NVRAM memory 100 may be provided in the local game server 64 to store game-related data for gaming transactions conducted by players operating the stationary hardwired player stations 16-20 in the communal gaming system 12 of FIG. 1. Both of these memories 100, 110 may be consulted in the event of any disputes or alleged discrepancies in wagering and game outcomes.

The local game server 64 may also include a game engine manager 96 that contains a random number generator (RNG) and game rules such that a wireless gaming device 14A-14D user may choose to play a game directly on the local game server 64 or on a live game being played on the external game server 31 through the local game server 64. Thus, the game engine manager 96 may execute an appropriate game depending on the game configuration selected (e.g., by a casino operator) through a game engine configuration unit 98. In one embodiment, the game engine manager 96 is stateless and does not track any payment/credit information for the local game players (i.e., the players operating the hardwired player stations 16-20). Such information may, instead, be sent to the device manager 104 in the device server, which can also track user accounts. The executed game code information may be sent to the device server 62 via the game engine manager 96 so that the wireless game players are also offered the same communal game as the players at hardwired player stations 16-20 on the casino floor 84. The game engine manager 96 may also monitor and track game data generated by hardwired player stations 16-20 (FIG. 1) and effectuate the game data storage in its memory 100. During various game executions, respective game engine objects 97 may be generated to monitor the execution, flow, and status of the respective communal games. In an embodiment, a separate game engine object 97 exists in the local game server 64 for each communal game operating through that local game server 64. Thus, the local game server 64 and the device server 62 may be operatively linked to offer the same communal game to mobile as well as stationary game players, thereby significantly expanding the number of players that can participate in the same game.

As mentioned before, the remote logging server 90 may log information related to gaming transactions (including, for example, wagers placed, winning wagers, pay table values, etc.), game outcomes, and other system events (e.g., malfunctions reported, inaccuracies detected, device failures detected, etc.) supplied to it through the device server 62, but may not necessarily be restricted to device server-specific information (i.e., similar information related to the local game server 64 is also recorded in the remote logging server 90). The information recorded in the logging server 90 may be useful in the event of any inquiry, dispute, or request for data verification. The communication link 94 between the logging server 90 and the financial server 71 may be a one-way (read-only) link to prevent any data corruption or loss for the data in the logging server 90 because integrity of data in the logging server 90 is not only desirable, but may be necessary to comply with a jurisdiction's gaming laws. In the embodiment of FIG. 4, the data sent from the device server 62 to the remote logging server 90 is sent over a one-way communication link 91 to maintain the integrity of data stored in the logging sever 90. The communication may be a two-way communication link (shown by optional link 91A), if desired. The financial sever 71 may alternately access appropriate data from the logging server 90 to carryout player-specific account management and reporting based on the player's gaming transactions recorded in the logging server 90.

Although the financial server 71 illustrated in FIG. 4 has a one-way communication link with the device sever 62, in other embodiments, the financial server 71 may have a bi-directional communication with the device server 62 via the casino network 68 as illustrated in FIG. 3. Alternatively, a one-way communication link between the financial sever 71 and the device server 62 may be implemented as desired by the casino system designer. Additionally, in the embodiment of FIG. 4, two firewalls 92-93 are shown to further provide secure communication and interchange of gaming data, system information, control signals, etc. The first firewall 92 may be provided between various wireless access points 85A-85C communicating with the device server 62 so as to further secure data communication from the wireless gaming devices 14A-14C and preserve the integrity of gaming transactions carried out by the users of wireless gaming devices 14A-14C. The second firewall 93 may be provided between the cashier's cage 72 and the financial server 71 so as to secure account/finance-related data communication between workstations 80A-80B in the player transaction station 80 and the financial server 71.

Referring now to FIG. 5C, if a player is running low on funds (block 240) while playing a game on the casino floor 84, the player can replenish the player's account at that time (which is after initial check-out) by returning to the cashier's cage 72 for the addition of funds to the player's WGD 14A-14C (blocks 241, 242). In an alternative embodiment, after initial check-out, the player can add funds to their account using pre-designated kiosks (not shown) within the casino wherein the checked-out wireless gaming device (e.g., WGD 14A) can be inserted into a cradle (not shown) and then authenticated (which may be automatically performed by the kiosk) in a manner that was described before in connection with the wireless gaming device 14A-14C initial check-out procedure (blocks 243, 244). In a further embodiment, wireless replenishment of player account funds may be provided (blocks 245, 246). In this case, if the checked-out WGD 14A has a built-in credit card reader, then the player can swipe the player's credit card, casino card or other card to initiate a funds transfer. The swiped card data may be collected at the device manager 104 in the device server 62 and then forwarded to the financial server 71. The financial server 71 may verify the authenticity of the card (e.g., from the player-identifying information stored therein and retrieved using the player-ID supplied from the device manager 104) (block 247) and establish the new credit amount requested by the player using the player control buttons 46 on the WGD 14A (block 248). If the WGD 14A does not have a built-in credit card reader, the player may be provided with an access code that the player can enter using the player control buttons 46 on the WGD 14A to access the device server 62 in a funds transfer mode (block 250). In the funds transfer mode, a fixed, predetermined amount of credit (not under player control) may be added to the player's account. Upon receiving the player access code (and device-ID or other desired information that may be automatically transmitted by the WGD 14A), the device manager 104 in the device server 62 may retrieve the player-ID stored therein (and associated with the device-ID assigned earlier at the time of device check-out) and supply that information to the financial server 71 with an instruction to initiate automatic funds transfer in the predetermined amount using player card information stored therein (block 252). Upon successful transfer of new funds into the player's account, the device server 62 may send a message for the same to the corresponding WGD 14A through the secure wireless channel 86 (block 256). The processor 50 in the WGD 14A may then display the new electronic credits on the device display 47 to inform the player of the new account balance (block 258). Other ways of replenishing the player account during a game play may also be devised depending on how the wireless gaming is implemented. If additional funds cannot be successfully transferred to player's account (block 251), the financial server 71 may notify the casino cage operator (through a message on a workstation 80A or 80B, for example) of the failed attempt to replenish the player account and may also send an appropriate message to the device server 62 through the casino network 68 (block 254).

Referring now to the method 112 illustrated in FIG. 5D, initially, as described above with reference to FIG. 5B, when checking out a WGD 14A-14C, the purchased electronic credits are stored in the financial server 71 and displayed on the checked-out WGD (e.g., WGD 14A) to enable the player to keep track of the player's wagering activities (blocks 114 and 116). In addition, the wireless gaming device 14A-14D (FIG. 1) may display the name of, or announce the name of, a game that the player may participate in (e.g., communal game) (block 117). The wireless gaming devices (e.g., WGDs 14A-14D) may be configured in such a way that when a player is in the legal gaming area and in the vicinity of a communal gaming system (e.g., the gaming system 12 in FIG. 1), the player's wireless gaming device (e.g., WGD 14A) displays the communal game being played at the gaming system 12. In one embodiment, the indicator 42 (FIG. 1) on the communal gaming system 12 may continuously transmit or broadcast game signals to wireless access points (e.g., points 85A-85C in FIG. 4) in the vicinity thereof. The wireless access points, in turn, may broadcast these signals further throughout a specific casino area around the gaming system 12. Any wireless gaming devices 14A-14C in the vicinity of such wireless access points may pick up these broadcast signals announcing the communal game being played at the nearby gaming system 12. In another embodiment, the indicator 42 may itself function as one of the wireless access points to broadcast the game signals to nearby wireless gaming devices 14A-14C on the casino floor. As noted before, a communal game is a casino game whose pace and outcomes are controlled by the local game server 64 and the player may choose to participate in the communal game, but may not control the outcome or pace of the game.

Once the player's WGD 14A displays the desired game (i.e., when the WGD 14A is in the vicinity of the gaming system 12 offering the desired game), the player may locate the gaming system 12 offering the game the player wishes to play (block 118) and may “link” the WGD 14A to the gaming system 12 (block 120). In one embodiment, the player may physically place the WGD 14A at a communication port (not shown) located on the communal gaming system 12 (and dedicated for “linking” of wireless gaming devices to the gaming system 12) for several seconds to establish a communication link with that specific gaming system 12 (through the nearby wireless access points 85A-85C and the device server 62, for example). In an alternative embodiment, the player's WGD 14A may be communicatively “linked” to the gaming system 12 (i.e., to the local game server 64) via the device server 62 when the player selects that game from the game menu display on the player's WGD 14A which is offered at the gaming system 12.

After receiving a confirmation (e.g., from the device server 62 in communication with the local game server 64 operating the gaming system 12) that the communication between the player's WGD 14A and the gaming system 12 (i.e., the local game server 64) is established (block 121), the player may start playing the game by placing bets electronically and wirelessly using the player's WGD 14A (block 122). During the communal game play, the local game server 64 operates to generate the game outcomes (block 124), which are sent to the player's WGD 14A via the wireless device server 62. As set forth above, during game play, the local game server 64 may perform such functions as parameter validation to assure the WGD 14A-14D users are following house rules. For example, the local game server 64 may determine whether the wireless gaming device 14A-14D user is attempting to wager more than the maximum wager permitted or attempting to wager less than the minimum wager permitted, and whether the wireless gaming device 14A-14D user is attempting to place a wager at an inappropriate time. The local game server 64 may then prevent the wireless gaming device 14A-14D user from performing any such activity falling outside the house rules and, if desired, inform the wireless gaming device 14A-14D user they are attempting an improper operation and ask that the user place a wager conforming to the house rules.

Based on the player's bet and game outcome, the wireless device server 62 settles the bet and awards/subtracts electronic credits on the player's WGD 14A wirelessly (block 126). In addition, as part of block 126, the device server 62 tracks the score/outcome of the game play based on the common outcome of the game, and may terminate the play session when the player's electronic credit balance reaches “0.” The player may purchase more credit to return to the game or replenish the credit balance before it reaches “0” using one of the methods discussed above. Moreover, as mentioned above, the local game server 64 may periodically require the player of a wireless gaming device 14A-14D to input a player identifier such as e.g., a fingerprint from reader 49, a code from a card swiped into the card reader 49A, a personal identification number entered at the player controls 46, or other identifier to ensure that the player using the WGD 14A-14D is authorized to use the device. If it is determined that the player is not authorized, the local game server 64 may terminate the play session and alert casino personnel to the unauthorized access. The player may continue playing different rounds of the game based on the credit balance available in the player's account (as displayed on the display 47 of the WGD 14A) as indicated by the decision loop at block 128.

At any time when the player wishes to stop playing the specific game offered at the communal gaming system 12, the player may simply walk away from the play area. The communication between the WGD 14A and the gaming system 12 may be terminated when the physical distance between the two devices exceeds certain limits (depending on the wireless protocol employed, signal power levels, etc.). In other embodiments, alternative methods may be implemented to terminate the communication between the gaming system 12 and the player's WGD 14A. Such methods include, for example, pressing an on/off button (not shown) on the WGD 14A or physically placing the WGD 14A on a communication port (not shown) on the gaming system 12 and selecting a de-linking option (block 130). After de-linking the WGD 14A from a specific communal gaming system 12, the player may proceed to play a different communal game at a different gaming system by linking the WGD 14A to that new gaming system in the manner discussed above (block 132). When the player decides to conclude wireless gaming, the player may return the WGD 14A to the cashier's cage 72 (or to a suitable kiosk designated for returning such wireless gaming devices 14A-14C) and cash out the player's winnings, if any (block 134). An operator at the cashier's cage 72 may reconcile the player's account by verifying and settling it through the financial server 71 using the workstation (e.g., the workstation 80A) in the player transaction station 80. In this manner, wireless communal gaming may be carried out in addition to such communal gaming at stationary hardwired player stations 16-20.

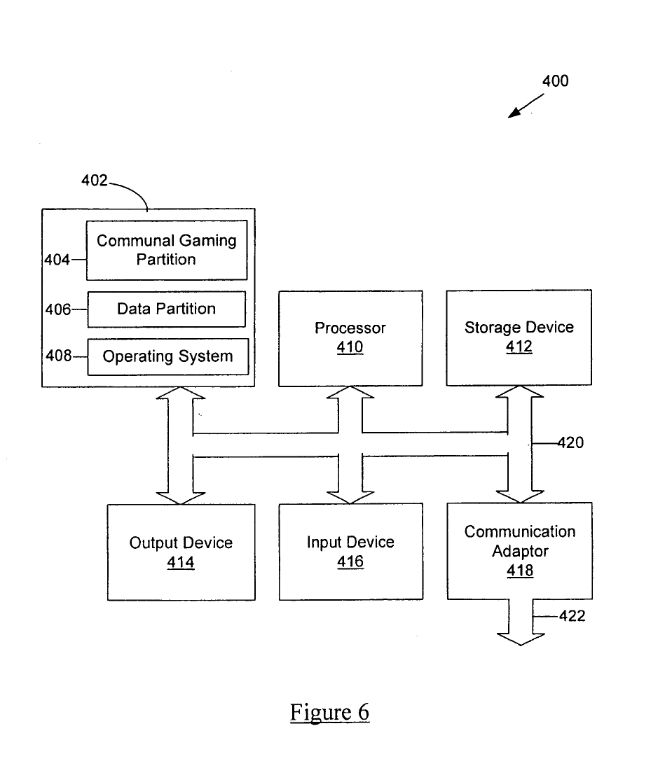

FIG. 6 illustrates an embodiment of a node 400 that may be used as one or more of the wireless gaming devices 14A-14D, the external game server 31, the individual player controllers 21-25, the device server 62, the local game server 64, or any other processor-based device described herein. The node 400 illustrated in FIG. 6 includes memory 402, a processor 410, a storage device 412, an output device (e.g., display or monitor) 414, an input device (e.g., keyboard, mouse, joystick, etc.) 416, and a communication adaptor 418. Communication between the processor 410, the storage device 412, the output device 414, the input device 416, and the communication adaptor 418 is accomplished by way of one or more communication buses 420. Those buses 420 may include, for example, a system bus, a peripheral component interface bus, or an Industry Standard Architecture bus. It should be recognized that the node 400 may have fewer components or more components than shown in FIG. 6. For example, if a user interface is not desired, the input device 416 and/or output device 414 may not be included with the node 400.

The memory 402 may, for example, include random access memory (RAM), static or dynamic RAM, and/or read only memory (ROM) (e.g., programmable ROM, erasable programmable ROM, or electronically erasable programmable ROM) and may store computer program instructions and information. The memory 402 may also be partitioned into sections including an operating system partition 408 where system operating instructions are stored, a data partition 406 in which data is stored, and a communal gaming partition 404 in which communal gaming operational instructions are stored. The communal gaming partition 404 includes circuitry or code that performs some or all of the functions described herein including, for example, game rules. The communal gaming partition 404 may store program instructions and allow execution by the processor 410 of those program instructions. The data partition 406 may furthermore store data such as, for example, cards associated with random numbers generated during game play.

The processor 410 may, for example, be an Intel® Pentium® type processor or another processor manufactured by, for example Motorola®, Compaq®, AMD®, or Sun Microsystems®. The processor 410 may furthermore execute the program instructions and process the data stored in the memory 402. In one embodiment, the instructions are stored in memory 402 in a compressed and/or encrypted format. As used herein the phrase, “executed by a processor” is intended to encompass instructions stored in a compressed and/or encrypted format, as well as instructions that may be compiled or installed by an installer before being executed by the processor 410.

The storage device 412 may, for example, be non-volatile battery backed RAM, a magnetic disk (e.g., floppy disk and hard drive), optical disk (e.g., CD-ROM or DVD) or any other device or signal that can store digital information. The communication adaptor 418 permits communication between the node 400 and other devices coupled to the communication adaptor 418 at the communication adaptor port 422 including, for example, a chip valuation device (not shown) and a chip sorter (not shown). The communication adaptor 418 may be a network interface or, alternately or in addition, may be coupled directly to one or more other devices through one or more input/output adaptors (not shown).

The input device 416 may include a card reader, keyboard, mouse, or any combination of input devices desired. The output device 414 may include a monitor, printer, or any combination of output devices desired. It will be recognized, however, that the node 400 does not necessarily need to have an input device 416 or an output device 414 to operate. Moreover, the storage device 412 may also not be necessary for operation of the node 400 as data required or desired for wireless communal gaming operation may be stored in memory, for example.

The foregoing describes various embodiments of a system and method for wireless communal gaming in a casino environment. As mentioned hereinbefore, currently, communal games are generally presented on large free-standing gaming devices (e.g., slot machines) or as table games (e.g., Baccarat or Roulette) in a casino. A substantial disadvantage to the way such games are currently presented is that a player may participate in a game in only certain specified locations within the gaming environment (e.g., a casino). For example, in order to play Baccarat, the player may have to travel through a large hotel/casino complex to a specific gaming area where the Baccarat table is located. Such a restrictive gaming environment hampers players' accessibility to different communal games and reduces their opportunities to play such games. The present disclosure thus relates to a system and method for playing communal wagering games in a casino environment in a wireless manner, allowing greater player mobility within the casino establishment and also allowing a large number of players (players playing wirelessly as well as players playing traditionally at a hardwired player station 16-20) to participate in a common game, thereby increasing the capacity of existing communal game tables. The wireless gaming approach according to one embodiment of the present disclosure may reduce or eliminate the need for the player to travel through a large hotel/casino to a specific gaming area where the desired gaming table is located. Furthermore, the wireless gaming approach may further minimize search time for a player to search for a particular game and, potentially eliminate the wait time when a player finds that the desired game table location is occupied by another player. The wireless or mobile player may participate in the communal game regardless of whether there is a hardwired player station 16-20 available. The system of the present disclosure includes one or more wireless gaming device each equipped with a display, one or more gaming servers configured to communicate wirelessly with the wireless gaming devices and hardwired player stations 16, and one or more financial servers configured to record financial transactions for players playing communal games of chance on the handheld gaming devices.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

1. A gaming system, comprising:
an interactive communal computer-based wagering game platform, the platform comprising an interactive communal platform game server communicating game information by way of a hardwired connection with multiple physical stationary player stations for playing the communal game and receiving a wager command from and providing a communal game outcome to a wireless gaming device by way of a secure wireless network.

2. The gaming system of claim 1 and further comprising a device server in communication with the game server and the wireless gaming device, the device server capable of managing communication of the wager command and the communal game outcome.

3. The gaming system of claim 2 and further comprising a logging server in communication with the device server, the logging server capable of logging game server transactions, system events, and game outcomes.

4. The gaming system of claim 2 and further comprising a financial server in communication with the device server.

5. The gaming system of claim 4 and further comprising a management work station in communication with the financial server for initiating funds transfers to and from the device server.

6. The gaming system of claim 5 and further comprising a firewall between the financial server and the management work station.

7. The gaming system of claim 2 and further comprising a firewall between the secure wireless network and the device server.

8. The gaming system of claim 3, wherein communication between the device server and the logging server is one-way.

9. The gaming system of claim 3, wherein communication between the device server and the logging server is two-way.

10. The gaming system of claim 1, wherein each wireless device comprises a timer for shutting down said device.

11. The gaming system of claim 1, wherein each wireless device comprises a fingerprint reader for inputting fingerprint information of a player, wherein the fingerprint information is transmitted to the game server to authenticate the player of a respective device.

12. The gaming system of claim 1, wherein each wireless device comprises a card reader for inputting player information of a player, wherein the player information is transmitted to the game server to authenticate the player of a respective device.

13. The gaming system of claim 1, wherein the game server performs parameter validation to ensure that a player of any of the wireless devices complies with the rules of the communal game.

14. The gaming system of claim 12, wherein the game server prevents a player of any of the wireless devices from violating the rules of the communal game.

15. The gaming system of claim 1, wherein a first player associated with a first wireless device plays the game directly from the game server.

16. The gaming system of claim 15, wherein a second player associated with a second wireless device plays the game being played by players at the physical stationary player stations.

17. The gaming system of claim 1, further comprising at least one workstation for preparing the wireless devices for use in the game.

18. The gaming system of claim 17, wherein the at least one workstation establishes a player account for a respective wireless device when the device is checked out by the player.

19. A gaming system, comprising:
an interactive communal computer-based wagering game platform having an interactive communal platform game server executing a communal game, and a plurality of stationary player stations communicating with the game server by way of a hardwired connection to enable a player at each player station to play said communal game executed by said game server; and
a device server in communication with the game server and a plurality of wireless gaming devices, the wireless gaming devices communicating with the device server over a secure wireless network to enable a mobile player operating each corresponding wireless gaming device to play said communal game executed by said game server.

20. The gaming system of claim 19, further comprising a logging server in communication with the device server so as to log game server transactions, system events, and game outcomes.

21. The gaming system of claim 20, further comprising a financial server in communication with the logging server to provide financial management of mobile player accounts based on game-related information obtained from the game server.

22. The gaming system of claim 19, further comprising:
a management work station in communication with the financial server for initiating mobile player-specific funds transfer to and from said device server.

23. The gaming system of claim 22, further comprising a firewall between the financial server and the management work station.

24. The gaming system of claim 22, wherein each said wireless gaming device is in serial communication with said management work station prior to being issued to said mobile player for playing said communal game.

25. The gaming system of claim 19, further comprising a firewall between the secure wireless network and the device server.

26. The gaming system of claim 19, wherein communication between the device server and the logging server is one-way.

27. The gaming system of claim 19, wherein communication between the financial server and the logging server is one-way.

28. The gaming system of claim 19, wherein the communal game is one in which all players wager on a common outcome.

29. The gaming system of claim 19, wherein the communal game is one in which player decisions are limited to selecting and placing a wager in a predetermined time period that is fixed for all players playing said communal game.

30. The gaming system of claim 19, wherein the communal game is Baccarat.

31. The gaming system of claim 19, wherein the communal game is Roulette.

32. The gaming system of claim 19, wherein each wireless gaming device is configured to function as a dummy terminal incapable of executing program code for said communal game.

33. The gaming system of claim 19, wherein the interactive communal computer-based wagering game platform displays a virtual dealer.

34. A method of playing an interactive communal game executed by an interactive communal platform game server in communication with a plurality of stationary player stations by way of a hardwired connection, wherein the communal game is one in which all players wager on a common outcome and in which player decisions are limited to selecting and placing a wager in a predetermined time period that is fixed for all players playing the communal game, said method further comprising:
allowing a plurality of wireless gaming devices to wirelessly communicate with said game server so as to enable a player operating each corresponding wireless gaming device to play said communal game executed by said game server.

35. The method of claim 34, wherein at least one player operating at least one of the stationary player stations connected by hardwire to the game server plays the interactive communal game simultaneously with at least one player operating at least one of the wireless gaming devices.

36. The method of claim 34, further comprising displaying a virtual dealer to the plurality of stationary player stations communicating by way of a hardwired connection.

37. The method of claim 34, wherein a player operates the at least one wireless gaming device, said method further comprising periodically inputting player identification to ensure that the player is authorized to operate the wireless gaming device.

38. The method of claim 37, wherein the player identification is a fingerprint.

39. The method of claim 37, wherein the player identification is a code input from a card reader.

40. The method of claim 37, wherein the player identification is a personal identification number.

41. The method of claim 34, further comprising loading software applications on a wireless device when a player checks out the device.

42. The method of claim 34, further comprising establishing a player account for a wireless device when a player checks out the device.

43. A method of playing an interactive communal game, wherein the communal game is one in which all players wager on a common outcome and in which player decisions are limited to selecting and placing a wager in a predetermined time period that is fixed for all players playing the communal game on a stationary player station, said method comprising:
executing said communal game on an interactive communal platform game server connected by hardwire to each stationary player station;
enabling a player at each of a plurality of stationary player stations to play said communal game executed by said game server; and
allowing a plurality of wireless gaming devices to wirelessly communicate with said game server so as to enable a mobile player operating each corresponding wireless gaming device to play said communal game executed by said game server and also played by players at said stationary player stations.

44. The method of claim 43, further comprising:
maintaining a secure wireless communication between said plurality of wireless gaming devices and said game server.

45. The method of claim 43, further comprising:
allowing said mobile player to wirelessly replenish a player account at corresponding wireless gaming device while said communal game is being played.

46. (canceled)

47. The method of claim 43, further comprising displaying a virtual dealer to the plurality of stationary player stations.

48. A method of operating a first wireless gaming device, comprising: selecting one of a first game having game rules executed by a local wireless game server and a second game executed by a second interactive communal game server connected by hardwire to a plurality of stationary player stations.

49. (canceled)

50. The method of claim 48, further comprising a player operating a second wireless gaming device by selecting one of the first game having game rules executed by the local wireless game server and the second game executed by the second interactive communal game server.

51. The method of claim 50, wherein the game executed by the second interactive communal game server is a communal game for which a user of the first wireless gaming device and the player of the second wireless gaming device are wagering on a common outcome.

52. The method of claim 51, wherein the communal game is a communal game in which user and player decisions are limited to selecting and placing a wager in a predetermined time period that is fixed for all players.

53. The method of claim 48, wherein the first wireless gaming device communicates with the second interactive communal game server through the local wireless game server.

54. A gaming system, comprising:
a local wireless game server executing rules for a first game;
an external interactive communal platform game server executing rules for a second game and communicating with the local wireless game server; and
a wireless gaming device communicating wirelessly with the local wireless game server, the wireless gaming device having an input with which a user of the wireless gaming device may select to play the first game executed by the local wireless game server or the second game executed by the external interactive communal platform game server connected by hardwire to a plurality of stationary player stations and a display on which is displayed a result of the selected game.

55. (canceled)

56. The system of claim 54, wherein the game executed by the external interactive communal platform game server is a communal game in which a plurality of players wager on a common outcome.

57. The system of claim 56, wherein the communal game is a communal game in which player decisions are limited to selecting and placing a wager in a predetermined time period that is fixed for all players.
